(19) United States
(12) Patent Application Publication
(10) Pub. No.: US 2025/0357574 A1
(43) Pub. Date: Nov. 20, 2025

(54) BATTERY PACK ENCLOSURE, BATTERY PACK AND ENERGY STORAGE SYSTEM

(71) Applicant: Jinko Energy Storage Technology Co., Ltd., Haining (CN)

(72) Inventors: Yanyan SHI, Haining (CN); Yuanfu LV, Haining (CN); Yuanhang CHEN, Haining (CN)

(21) Appl. No.: 19/209,710

(22) Filed: May 15, 2025

(30) Foreign Application Priority Data
May 16, 2024 (CN) 202410611933.8

(51) Int. Cl. H01M 10/6556; H01M 10/613; H01M 10/651; H01M 10/6567; H01M 50/204

(52) U.S. Cl. CPC H01M 10/6556; H01M 10/613; H01M 10/651; H01M 10/6567; H01M 50/204

(57) ABSTRACT

Embodiments of the present disclosure relate to the field of energy storage, and in particular to an enclosure for a battery pack, a battery pack, and an energy storage system. The enclosure includes a coolant channel arranged inside the enclosure and a plurality of flow-diverting members. The coolant channel includes an inlet section, an outlet section, and a turning section connecting the inlet section with the outlet section. The plurality of flow-diverting members include first flow-diverting members arranged in the inlet section, third flow-diverting members arranged in the outlet section, and second flow-diverting members arranged in the turning section. In a first direction, the inlet section has a first width smaller than a second width of the outlet section, where the first direction refers to a width direction of the enclosure.

### CROSS REFERENCE TO RELATED APPLICATIONS

The present application claims the benefit of priority under the Paris Convention to Chinese Patent Application No. 202410611933.8 filed on May 16, 2024, which is incorporated herein by reference in its entirety.

### TECHNICAL FIELD

Embodiments of the present disclosure relate to the field of energy storage, and in particular to an enclosure for a battery pack, a battery pack, and an energy storage system.

### BACKGROUND

In existing liquid cooling techniques, the most common approach involves placing liquid cooled plates or cooling pipes inside the enclosure, which are installed independently of the modules and the enclosure. The liquid cooled plates are typically made from aluminum alloy and by using extrusion process. After forming flow channels on the liquid cooled plates by extrusion, the liquid cooled plates are assembled together and welded to form cooling channels. However, the airtightness at the weld seams of the cooling channels is difficult to control, leading to a low yield rate of airtightness, which in turn reduces the cooling performance of the liquid cooled plates.

In addition, the liquid cooled plates arranged separately inside the battery pack take up a large amount of space, thereby increasing the weight of the battery pack and reducing the energy density of the battery pack.

### SUMMARY

The embodiments of the present disclosure provide an enclosure for a battery pack, a battery pack, and an energy storage system, which at least facilitate the integration of the coolant channel within the enclosure and are conducive to improvement of the cooling performance of the enclosure.

Some embodiments of the present disclosure provide an enclosure for a battery pack, including: a coolant channel arranged inside the enclosure and a plurality of flow-diverting members. The coolant channel is configured to conduct a coolant inside and includes an inlet section, an outlet section, and a turning section connecting the inlet section with the outlet section. The plurality of flow-diverting members are configured to distribute flow of the coolant through the coolant channel and include first flow-diverting members arranged in the inlet section, second flow-diverting members arranged in the turning section, and third flow-diverting members arranged in the outlet section. In a width direction of the enclosure, the inlet section has a first width smaller than a second width of the outlet section.

In some embodiments, the first flow-diverting members are arranged at a first distribution density, the second flow-diverting members are arranged at a second distribution density, and the third flow-diverting members are arranged at a third distribution density. The second distribution density is greater than the first distribution density, and the second distribution density is greater than the third distribution density.

In some embodiments, the first distribution density is greater than the third distribution density.

In some embodiments, in a length direction of the enclosure, one respective first flow-diverting member of the first flow-diverting members has a first length, one respective second flow-diverting member of the second flow-diverting members has a second length, and one respective third flow-diverting member of the third flow-diverting members has a third length. The third length is greater than the first length, the third length is greater than the second length, and the first length is greater than second lengths of at least some of the second flow-diverting members.

In some embodiments, each first flow-diverting member of the first flow-diverting members is configured as an elongated structure extending along the length direction.

In some embodiments, the first flow-diverting members are grouped into N first flow-diverting member groups arranged at intervals along the width direction, each first flow-diverting member group of the N first flow-diverting member groups includes a respective plurality of first flow-diverting members arranged at intervals along the length direction, and N is a positive integer greater than or equal to 2. In the width direction, one respective first flow-diverting member of a N-th first flow-diverting member group has a width greater than or equal to a width of one respective first flow-diverting member of a (N−1)-th first flow-diverting member group.

In some embodiments, at least some of the third flow-diverting members are partially arranged in the turning section.

In some embodiments, one respective third flow-diverting member of the third flow-diverting members includes at least a first flow-diverting portion including a first flow-blocking portion located in the turning section and a first flow-guiding portion located in the outlet section, and the first flow-guiding portion forms a first groove extending toward the turning section along a length direction of the enclosure.

In some embodiments, one respective third flow-diverting member of the third flow-diverting members further includes a second flow-diverting portion including a second flow-guiding portion, a third flow-guiding portion, and a second flow-blocking portion located in the turning section and between the second flow-guiding portion and the third flow-guiding portion in the width direction. The second flow-blocking portion is respectively connected to the second flow-guiding portion and the third flow-guiding portion and forms a second groove together with the second flow-guiding portion and the third flow-guiding portion, and the second groove extends away from the turning section along the length direction.

In some embodiments, one respective third flow-diverting member of the third flow-diverting members further includes a third flow-diverting portion located between the first flow-diverting portion and the second flow-diverting portion, the third flow-diverting portion is S-shaped, one end of the third flow-diverting portion directly faces the first groove along the length direction, and the other end of the third flow-diverting portion directly faces the second groove along the length direction.

In some embodiments, the third flow-diverting portion forms two third grooves, one respective third flow-diverting member of the third flow-diverting members further includes fourth flow-diverting portions, one of the fourth flow-diverting portions is arranged between the first flow-diverting portion and the third flow-diverting portion, and the other of the fourth flow-diverting portions is arranged between the second flow-diverting portion and the third flow-diverting portion. One respective fourth flow-diverting portion of the fourth flow-diverting portions is Z-shaped, one end of the respective fourth flow-diverting portion is located in the first groove or the second groove, and the other end of the respective fourth flow-diverting portion is located in the third groove.

In some embodiments, a ratio of the second width to the first width ranges from 1.5 to 2.5.

In some embodiments, the enclosure further includes: an inlet arranged on a side of the inlet section away from the turning section in a length direction of the enclosure; and an outlet arranged on a side of the outlet section away from the turning section in the length direction.

In some embodiments, the turning section includes a first section and a second section, the first section directly faces the inlet section along a length direction of the enclosure, and the second section directly faces the outlet section along the second direction.

In some embodiments, the outlet section includes a third section and a fourth section, the third section directly faces the inlet section along the width direction, and the fourth section directly faces the turning section along the width direction.

In some embodiments, a distance between the inlet section and the outlet section along the width direction is in a range of 35 mm to 52 mm.

In some embodiments, a flow rate of a coolant has a first average value in the inlet section, the flow rate of the coolant has a second average value in the turning section, and the flow rate of the coolant has a third average value in the outlet section. The first average value is less than the second average value, and the second average value is less than the third average value.

In some embodiments, a flow resistance experienced by a coolant has a first average value in the inlet section, the flow resistance experienced by the coolant has a second average value in the turning section, and the flow resistance experienced by the coolant has a third average value in the outlet section. The first average value is greater than the third average value, and the third average value is greater than the second average value.

Some embodiments of the present disclosure provide a battery pack, including: the enclosure according to any one of the above embodiments.

In some embodiments, the battery pack further includes a plurality of cells. Each cell of the plurality of cells includes a top surface and a bottom surface that are opposite to each other along a thickness direction of the enclosure. The enclosure is located on a side of the top surface away from the bottom surface, or the enclosure is located on a side of the bottom surface away from the top surface.

Some embodiments of the present disclosure provide an energy storage system, including: the enclosure according to any one of the above embodiments, or the battery pack according to any one of the above embodiments.

The technical solutions provided in the embodiments have at least the following advantages.

On the one hand, the coolant channel in the enclosure is roughly divided into an inlet section, an outlet section, and a turning section, making the flow path of coolant flowing into the enclosure approximately C-shaped. In this way, the number of turns in the flow path of the coolant can be reduced, and the total length of the flow path of the coolant within the enclosure can be minimized, thereby ensuring that the coolant flows at a relatively high flow rate in the coolant channel, and guaranteeing better cooling performance of the coolant. On the other hand, flow-diverting members for disturbing the flow of the coolant are respectively arranged in the inlet section, the outlet section, and the turning section. In this way, flow rate of the coolant in the coolant channel can be increased, thereby improving the cooling performance of the coolant. The increased flow rate of the coolant also helps prevent impurities in the coolant from depositing in the coolant channel, thereby increasing the service life of the enclosure.

Furthermore, the first width of the inlet section is smaller than the second width of the outlet section, which helps reduce the volume of the inlet section that is mainly used to guide the coolant into the coolant channel to be smaller than the volume of the outlet section that is mainly used to guide the coolant out of the coolant channel. In this way, the flowing space in the coolant channel for the coolant can be constricted, thereby increasing the flow rate of the coolant at the inlet of the coolant channel. When the coolant flows into the outlet section, the larger volume of the outlet section can gradually reduce the flow rate of the coolant, thereby increasing the duration of the coolant flowing in the outlet section, and further improving the cooling performance of the coolant.

### BRIEF DESCRIPTION OF THE DRAWINGS

Exemplary illustrations of one or more embodiments are provided by reference to pictures in the corresponding accompanying drawings. These exemplary illustrations do not constitute a limitation on the embodiments. The elements denoted by the same reference numerals in the drawings represent elements similar to one another. The drawings do not constitute a scale limitation unless otherwise specified. In order to illustrate the technical solutions in related technologies or in the embodiments of the present disclosure more clearly, the drawings to be used in the embodiments will be briefly described below. It is obvious that the drawings mentioned in the following illustration are only some embodiments of the present disclosure. For those of ordinary skill in the art, other drawings may also be obtained in accordance with these drawings without any inventive effort.

FIG. 1 is a schematic top view of a first partial structure of the enclosure according to some embodiments of the present disclosure.

FIG. 2 is a schematic top view of a second partial structure of the enclosure according to some embodiments of the present disclosure.

FIG. 3 is a schematic top view of a third partial structure of the enclosure according to some embodiments of the present disclosure.

FIG. 4 is a schematic top view of a structure of an inlet section of a coolant channel in the enclosure according to some embodiments of the present disclosure.

FIG. 5 is a schematic top view of partial structures of a turning section and an outlet section of the coolant channel in the enclosure according to some embodiments of the present disclosure.

FIG. 6 is a schematic top view of a structure of a first flow-diverting portion in the enclosure according to some embodiments of the present disclosure.

FIG. 7 is a schematic top view of a structure of a second flow-diverting portion in the enclosure according to some embodiments of the present disclosure.

FIG. 8 is a schematic top view of a structure of a third flow-diverting portion in the enclosure according to some embodiments of the present disclosure.

FIG. 9 is a schematic perspective view of a partial structure of a battery pack according to some embodiments of the present disclosure.

FIG. 10 is a schematic perspective view of another partial structure of the battery pack according to some embodiments of the present disclosure.

### DETAILED DESCRIPTION OF THE EMBODIMENTS

As can be seen in the background, the cooling performance of the liquid cooled plate is desired to be improved.

The present embodiment provides an enclosure for a battery pack, a battery pack, and an energy storage system. On the one hand, the coolant channel in the enclosure is roughly divided into an inlet section, an outlet section, and a turning section, making the flow path of coolant flowing into the enclosure approximately C-shaped. In this way, the number of turns in the flow path of the coolant can be reduced, and the total length of the flow path of the coolant within the enclosure can be minimized, thereby ensuring that the coolant flows at a relatively high flow rate in the coolant channel, and guaranteeing better cooling performance of the coolant. On the other hand, flow-diverting members for disturbing the flow of the coolant are respectively arranged in the inlet section, the outlet section, and the turning section. In this way, flow rate of the coolant in the coolant channel can be increased, thereby improving the cooling performance of the coolant. The increased flow rate of the coolant also helps prevent impurities in the coolant from depositing in the coolant channel, thereby increasing the service life of the enclosure. Furthermore, the first width of the inlet section is smaller than the second width of the outlet section, which helps reduce the volume of the inlet section that is mainly used to guide the coolant into the coolant channel to be smaller than the volume of the outlet section that is mainly used to guide the coolant out of the coolant channel. In this way, the flowing space in the coolant channel for the coolant can be constricted, thereby increasing the flow rate of the coolant at the inlet of the coolant channel. When the coolant flows into the outlet section, the larger volume of the outlet section can gradually reduce the flow rate of the coolant, thereby increasing the duration of the coolant flowing in the outlet section, and further improving the cooling performance of the coolant.

Various embodiments of the present disclosure will be described in detail below with reference to the accompanying drawings. However, those of ordinary skill in the art shall understand that in the embodiments of the present disclosure, many technical details are provided to enable readers to better understand the embodiments of the present disclosure. However, even without these technical details and various changes and modifications based on the following embodiments, the technical solutions claimed in the embodiments of the present disclosure can still be implemented.

An enclosure for a battery pack is provided according to some embodiments of the present disclosure. The enclosure provided in some embodiments of the present disclosure will be described in detail below with reference to the accompanying drawings.

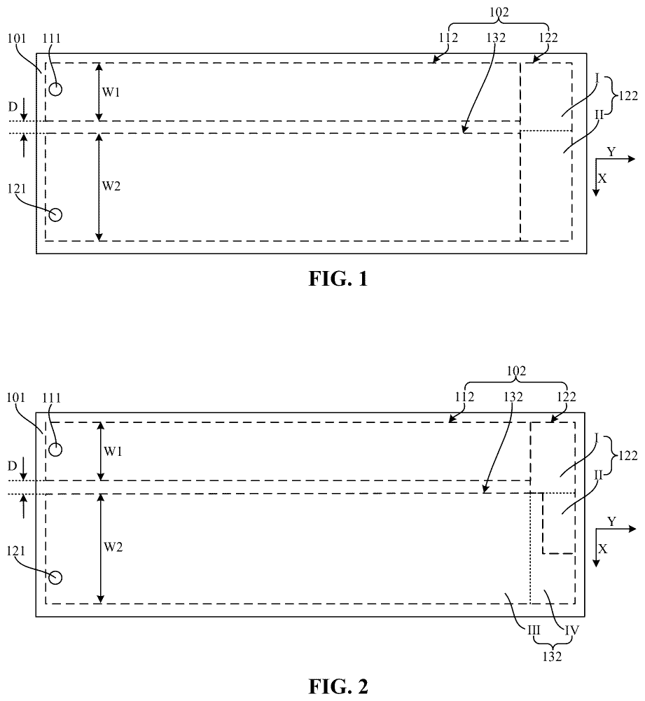

With reference to FIGS. 1 to 3, the enclosure 101 is applied to a battery pack and includes a coolant channel 102 arranged inside the enclosure 101 and a plurality of flow-diverting members 103. The coolant channel 102 includes an inlet section 112, an outlet section 132, and a turning section 122 connecting the inlet section 112 with the outlet section 132. The plurality of flow-diverting members 103 are configured to distribute flow of the coolant through the coolant channel and include first flow-diverting members arranged in the inlet section 112, third flow-diverting members arranged in the outlet section 132, and second flow-diverting members arranged in the turning section 122. In a first direction X, a first width W1 of the inlet section 112 is smaller than a second width W2 of the outlet section 132. The first direction X refers to a width direction of the enclosure 101.

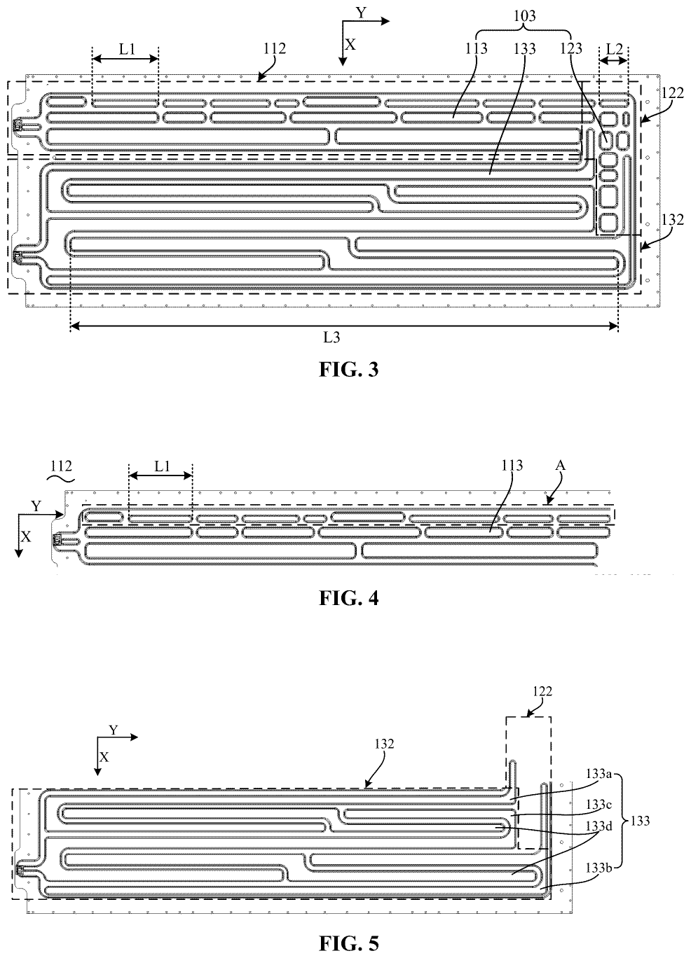

FIG. 1 is a schematic top view of a first partial structure of the enclosure according to some embodiments of the present disclosure. FIG. 2 is a schematic top view of a second partial structure of the enclosure according to some embodiments of the present disclosure. FIG. 3 is a schematic top view of a third partial structure of the enclosure according to some embodiments of the present disclosure. The positional relationship of the inlet section, outlet section, and turning section in FIG. 3 is as shown in FIG. 2.

It is noted that for clarity in illustrating the positional relationship of the inlet section 112, outlet section 132, and turning section 122 within the enclosure 101, the specific structure of the coolant channel 102 and the flow-diverting members 103 are not shown in FIGS. 1 and 2. In addition, the first width W1 of the inlet section 112 refers to the maximum width of the inlet section 112 along the first direction X, and the second width W2 of the outlet section 132 refers to the maximum width of the outlet section 132 along the first direction X.

It is noted that the enclosure 101 with the coolant channel being arranged inside can not only function as a liquid cooled plate but also serve as the casing of a battery pack. In other words, the enclosure 101 used as the casing of the battery pack and the liquid cooled plate are integrated into a single piece, which helps reduce the layout space occupied by the casing of the battery pack and the liquid cooled plate in the battery pack. This allows more internal space in the battery pack to be used for accommodating the battery cells, thereby increasing the energy density of the battery pack without increasing its overall volume. Furthermore, the enclosure 101, which is internally placed with a coolant channel, can cool and dissipate heat from the battery cells and other heat-generating components in the battery pack, helping to improve the service life of the battery pack.

It is noted that the cooling performance of the enclosure 101 includes but is not limited to: the cooling performance of the enclosure 101 on heat-generating components, such as the battery cells, in the battery pack. In some cases, the coolant channel in the enclosure 101 may be formed by using a blowing process. In other words, the enclosure 101 and the coolant channel designed inside it form an integrally molded structure, which helps improve the airtightness of the coolant channel and prevents leakage of the coolant within the coolant channel. This ensures that the coolant channel has sufficient coolant to effectively cool the heat-generating components, such as the battery cells, in the battery pack. Thus, the cooling performance of the enclosure 101 also includes the high airtightness of the coolant channel within the enclosure 101.

On the one hand, the coolant channel 102 is roughly divided into an inlet section 112, an outlet section 132, and a turning section 122, making the flow path of coolant flowing into the enclosure 101 approximately C-shaped. In this way, the number of turns in the flow path of the coolant can be reduced, and the total length of the flow path of the coolant within the enclosure 101 can be minimized, thereby ensuring that the coolant flows at a relatively high flow rate in the coolant channel 102, and guaranteeing better cooling performance of the coolant.

On the other hand, flow-diverting members 103 for disturbing the flow of the coolant are respectively arranged in the inlet section 112, the outlet section 132, and the turning section 122. In this way, flow rate of the coolant in the coolant channel 102 can be increased, thereby improving the cooling performance of the coolant. The increased flow rate of the coolant also helps prevent impurities in the coolant from depositing in the coolant channel 102, thereby increasing the service life of the enclosure 101.

Furthermore, the first width W1 of the inlet section 112 is smaller than the second width W2 of the outlet section 132, which helps reduce the volume of the inlet section 112 that is mainly used to guide the coolant into the coolant channel 102 to be smaller than the volume of the outlet section 132 that is mainly used to guide the coolant out of the coolant channel 102. In this way, the flowing space in the coolant channel 102 for the coolant can be constricted, i.e. the volume of the inlet section 112 is constricted, thereby increasing the flow rate of the coolant at the inlet of the coolant channel 102. When the coolant flows into the outlet section 132, the larger volume of the outlet section 132 can gradually reduce the flow rate of the coolant, thereby increasing the duration of the coolant flowing in the outlet section 132, and further improving the cooling performance of the coolant.

It is noted that the coolant in the coolant channel 102 flows through the inlet section 112, the turning section 122, and the outlet section 132 sequentially. Therefore, the coolant in the inlet section 112, after cooling the heat-generating components in the battery pack, flows through the turning section 122 and ultimately enters the outlet section 132. As a result, the coolant stays in the inlet section 112 for a duration shorter than in the outlet section 132 in the enclosure 101. Additionally, the temperature of the coolant in the inlet section 112 is lower than that of the coolant in the outlet section 132. Based on this, designing the first width W1 of the inlet section 112 to be smaller than the second width W2 of the outlet section 132 helps ensure that the flow rate of the coolant in the inlet section 112 is higher than that in the outlet section 132. This also increases the duration of the higher-temperature coolant staying in the outlet section 132, thereby preventing the cooling performance of the coolant from deteriorating due to the temperature rise of the coolant flowing into the outlet section 132. In this way, the negative impact of the temperature difference between the coolant in the inlet section and in the outlet section on the cooling performance of the coolant can be reduced, thereby helping balance the cooling performance of the coolant in the inlet section 112 and in the outlet section 132, thereby improving the overall cooling performance of the coolant.

In other words, the flow rate of the coolant in sections of the coolant channel 102 is regulated to ensure that the coolant maintains good cooling performance as the temperature of the coolant gradually rises within the coolant channel 102. To this end, the first width W1 of the inlet section 112 is designed to be smaller than the second width W2 of the outlet section 132.

It is noted that the cooling performance of the coolant includes, but is not limited to, the cooling performance of the coolant on heat-generating components such as the battery cells in the battery pack.

Some embodiments of the present disclosure will be described more specifically below with reference to the accompanying drawings.

In some embodiments, with reference to FIG. 1 or FIG. 2, a ratio of the second width W2 to the first width W1 ranges from 1.5 to 2.5. A ratio of the second width W2 to the first width W1 less than 1.5 is not conducive to increasing the volume difference between the inlet section 112 and the outlet section 132, and therefore not conducive to increasing the difference in the flow rate of the coolant between the inlet section 112 and the outlet section 132. This limits the effect of reducing the adverse impact of the temperature difference of the coolant in the inlet section 112 and in the outlet section 132 on the cooling performance of the coolant. When the ratio of the second width W2 to the first width W1 exceeds 2.5, the volume difference between the inlet section 112 and the outlet section 132 becomes too large. This may result in a case where the inlet section 112 has been fully filled with coolant, while the outlet section 132 requires more coolant than can be supplied, leading to an underutilized coolant channel 102 by the coolant, and being prejudicial to improvement of the cooling performance of the enclosure 101. Therefore, the ratio of the second width W2 to the first width W1 ranging from 1.5 to 2.5 is beneficial for ensuring an appropriate flow rate difference of the coolant between the inlet section 112 and the outlet section 132. This helps balance the cooling effect of the coolant in the inlet section 112 and the outlet section 132, ensuring the coolant channel 102 is fully filled with coolant evenly, thereby improving the utilization of the coolant channel 102 and the cooling performance of the enclosure 101.

In some examples, the ratio of the second width W2 to the first width W1 may be 1.65, 1.85, 1.96, 2.00, 2.15, 2.36, and so on.

In some examples, the first width W1 may be in a range of 180 mm to 200 mm. For instance, the first width W1 may be 182.5 mm, 183 mm, 184.5 mm, 185 mm, 186.5 mm, 188.5 mm, 190 mm, 192 mm, 193 mm, 194 mm, 195 mm, 195.5 mm, 196 mm, 197 mm, 198 mm, 198.5 mm, 199 mm, or 199.5 mm.

In some examples, the second width W2 may be in a range of 400 mm to 430 mm. For instance, the second width W2 may be 403 mm, 405 mm, 406 mm, 406.5 mm, 407 mm, 408 mm, 410 mm, 412 mm, 414 mm, 415 mm, 416 mm, 418 mm, 420 mm, 422 mm, 423 mm, 424 mm, 425 mm, 426 mm, 427 mm, 428 mm, or 429 mm.

The following provides a detailed description of the positional relationship between the inlet section 112, the outlet section 132, and the turning section 122.

In some embodiments, with reference to FIG. 1 or FIG. 2, the turning section 122 includes a first section I and a second section II. The first section I directly faces the inlet section 112 along a second direction Y, and the second section II directly faces the outlet section 132 along the second direction Y, where the second direction Y is the length direction of the enclosure 101. In other words, the first section I communicates with the inlet section 112, and the second section II communicates with the outlet section 132, such that the flow path of the coolant inside the enclosure 101, i.e., the coolant channel 102, is approximately C-shaped.

It is noted that in FIG. 1, the approximate positions of the inlet section 112, outlet section 132, and turning section 122 within the enclosure 101 are indicated by three rectangular dashed boxes of different sizes. In practical applications, a plane formed by the first direction X and the second direction Y serves as a reference plane, and the orthogonal projection of any one of the inlet section 112, the outlet section 132, or the turning section 122 onto the reference plane may be rectangular or any other regular or irregular polygon, and the shapes of the orthogonal projections of the inlet section 112, the outlet section 132, and the turning section 122 on the reference plane may depend on actual situations.

For example, in some cases, with reference to FIG. 2, when the turning section 122 includes the first section I and the second section II, the outlet section 132 may include a third section III and a fourth section IV, where the third section III directly faces the inlet section 112 along the first direction X, and the fourth section IV directly faces the turning section 122 along the first direction X.

In an example, with reference to FIG. 2, in the second direction Y, the width of the first section I may be greater than the width of the second section II, in order to reserve more layout space within the enclosure 101 for the outlet section 132, facilitating the layout of the flow path in the coolant channel 102 and regulating the flow rate of the coolant within the outlet section 132. Based on this, an edge of the fourth section IV may be aligned with an edge of the turning section 122.

It is noted that in both FIG. 1 and FIG. 2, the first section I and the second section II of the turning section 122 are delineated by dense dashed lines, and in FIG. 2, the third section III and the fourth section IV of the outlet section 132 are also delineated by dense dashed lines.

In some embodiments, with reference to FIG. 1 or FIG. 2, a distance D between the inlet section 112 and the outlet section 132 along the first direction X is in a range of 35 mm to 52 mm. For example, the distance D between the inlet section 112 and the outlet section 132 along the first direction X may be 36 mm, 37 mm, 37.5 mm, 38 mm, 40 mm, 42 mm, 43 mm, 45 mm, 47 mm, 49 mm, 50 mm, or 51 mm, etc.

It is noted that the distance D less than 35 mm could affect the structural stability of the portions of the enclosure 101 that are not configured to form the coolant channel. These portions being not configured to form the coolant channel may be considered as reinforcement ribs of the entire enclosure 101. For example, the portions of the enclosure 101 at the flow-diverting members 103 and the distance D may all be considered as reinforcement ribs of the enclosure 101 that support the coolant channel. Therefore, the distance D less than 35 mm is unfavorable for ensuring that the portion of the enclosure 101 at the distance D has a sufficiently high support strength. When the distance D is greater than 52 mm, the distance between the inlet section 112 and the outlet section 132 becomes too large, requiring a larger turning section 122. The coolant will take a longer time to flow from the inlet section 112 to the outlet section 132 through the turning section 122, which is not conducive to maintaining a high flow rate of the coolant, and therefore is not conducive to maintaining good temperature management efficiency for the battery cells using the enclosure 101. Therefore, the distance D between the inlet section 112 and the outlet section 132 along the first direction X should range from 35 mm to 52 mm inclusive, which helps to improve the support effect of the enclosure 101 for the coolant channel, ensures good overall structural stability of the enclosure 101, and also helps to maintain good temperature management efficiency for the battery cells using the enclosure 101.

In some examples, the distance D between the inlet section 112 and the outlet section 132 along the first direction X ranges from 40 mm to 50 mm inclusive.

In some embodiments, with reference to FIG. 2 and FIG. 3, the first flow-diverting members 113 arranged in the inlet section 112 are arranged at a first distribution density, the second flow-diverting members 123 arranged in the turning section 122 are arranged at a second distribution density, and the third flow-diverting members 133 arranged in the outlet section 132 are arranged at a third distribution density. The second distribution density is greater than the first distribution density, and the second distribution density is greater than the third distribution density.

It is noted that the flow path of the coolant in the enclosure 101 is approximately C-shaped. Not only does the junction between the turning section 122 and the inlet section 112 have a corner, but the junction between the turning section 122 and the outlet section 132 also has a corner. The coolant needs to flow from the inlet section 112 to the outlet section 132 through the turning section 122, which means that the coolant is likely to encounter significant resistance at these corners. As a result, impurities in the coolant are prone to deposit at these corners, further obstructing the flow of the coolant and potentially blocking the coolant channel 102. In view of this, the flow-diverting members 103 are designed to have the highest distribution density in the turning section 122, i.e., the second distribution density, among the inlet section 112, the outlet section 132, and the turning section 122. This design maximizes the turbulence of the coolant in the turning section 122, increasing its flow rate and enhancing the turbulence of the coolant in the turning section 122. This helps prevent the impurities from depositing in the turning section 122, ensuring that the coolant circulates smoothly in the coolant channel 102 and prolongs the service life of the enclosure 101.

It is noted that the distribution density refers to the number of flow-diverting members 103 that can be arranged within a unit volume. Specifically, the first distribution density refers to the number of flow-diverting members 103 arranged in a unit volume of the inlet section 112, the third distribution density refers to the number of flow-diverting members 103 arranged in a unit volume of the outlet section 132, and the second distribution density refers to the number of flow-diverting members 103 arranged in a unit volume of the turning section 122. Therefore, the second distribution density being greater than the first distribution density indicates that, given the same arrangement volume, the number of flow-diverting members 103 arranged in the turning section 122 is greater than the number of flow-diverting members 103 arranged in the inlet section 112. Similarly, the second distribution density being greater than the third distribution density indicates that, given the same arrangement volume, the number of flow-diverting members 103 arranged in the turning section 122 is greater than the number of flow-diverting members 103 arranged in the outlet section 132.

In addition, the shapes or sizes of the flow-diverting members 103 may be the same or different, regardless of whether they are arranged in a same section of the inlet section 112, outlet section 132, and turning section 122, or respectively arranged in two or more sections of the inlet section 112, outlet section 132, and turning section 122.

In some embodiments, with reference to FIG. 3, the first distribution density is greater than the third distribution density.

With reference to FIG. 2 and FIG. 3, on the basis that the first width W1 of the inlet section 112 is smaller than the second width W2 of the outlet section 132, the number of flow-diverting members 103 arranged per unit volume in the inlet section 112 is greater than the number of flow-diverting members 103 arranged per unit volume in the outlet section 132. As a result, the disturbance effect on the coolant is greater in the inlet section 112 compared to the outlet section 132, which helps further increase the flow rate of the coolant in the inlet section 112.

In some embodiments, with reference to FIG. 2 and FIG. 3, in a second direction Y, one respective first flow-diverting member of the first flow-diverting members 113 has a first length L1, one respective second flow-diverting member of the second flow-diverting members 123 has a second length L2, and one respective third flow-diverting member of the third flow-diverting members 133 has a third length L3. The third length L3 is greater than the first length L1, the third length L3 is greater than the second length L2, and the first length L1 is greater than second lengths L2 of at least some of the second flow-diverting members 123, where the second direction Y refers to a length direction of the enclosure 101.

In other words, among the first flow-diverting members 113, the second flow-diverting members 123, and the third flow-diverting members 133, one respective third flow-diverting member of the third flow-diverting members 133 has the greatest length along the second direction Y. The flow-diverting function of the third flow-diverting members 133 can help to extend the continuous flow path of the coolant in the outlet section 132 along the second direction Y, thereby increasing the duration that the coolant flows in the outlet section 132.

In some examples, the first length L1 may range from 86 mm to 960 mm. For example, the first length L1 may be 149 mm, 229 mm, 256 mm, 321 mm, 358 mm, or 835 mm, etc.

In some examples, the second length L2 may range from 24 mm to 102 mm. For example, the second length L2 may be 46 mm, 47 mm, 63 mm, or 64 mm, etc.

In some examples, the third length L3 may range from 1850 mm to 1965 mm. For example, the third length L3 may be 1856 mm, 1900 mm, or 1961 mm, etc.

It is noted that at least one of the first flow-diverting members 113 may have first length(s) L1 different from that of the remaining first flow-diverting members 113, at least one of the second flow-diverting members 123 may have second length(s) L2 different from that of the remaining second flow-diverting members 123, and at least one of the third flow-diverting members 133 may have third length(s) L3 different from that of the remaining third flow-diverting members 133. Based on this, the third length L3 being greater than the first length L1 indicates that the third length L3 of any one of the third flow-diverting members 133 is greater than the first length L1 of any one of first flow-diverting members 113, and the third length L3 being greater than the second length L2 indicates that the third length L3 of any one of third flow-diverting members 133 is greater than the second length L2 of any one of second flow-diverting members 123.

It is noted that the first length L1 being greater than second lengths L2 of at least some of the second flow-diverting members 123 indicates that: in some cases, the first length L1 of any one of the first flow-diverting members 113 is greater than the second lengths L2 of some of the second flow-diverting members 123, while the second lengths L2 of the remaining second flow-diverting members 123 may be greater than the first length L1 of at least one of the first flow-diverting members 113; in some other cases, the first length L1 of any one of the first flow-diverting members 113 is greater than the second length L2 of any one of the second flow-diverting members 123. The following provides a detailed description of the first flow-diverting members 113.

In some embodiments, with reference to FIG. 4, FIG. 4 is a schematic top view of a structure of an inlet section of a coolant channel in the enclosure according to some embodiments of the present disclosure, each first flow-diverting member of the first flow-diverting members 113 may be configured as an elongated structure extending along the second direction Y, in order to guide the coolant in the inlet section 112 to flow predominantly along the second direction Y.

In some embodiments, with reference to FIG. 4, the first flow-diverting members 113 are grouped into N first flow-diverting member groups A arranged at intervals along the first direction X, each first flow-diverting member group of the N first flow-diverting member groups A includes a respective plurality of first flow-diverting members 113 arranged at intervals along the second direction Y, and N is a positive integer greater than or equal to 2.

It is noted that the N first flow-diverting member groups A can divide the coolant in the inlet section 112 into (N+1) sub-flows. Adjacent sub-flows merge with each other at the spacing between adjacent first flow-diverting members 113 along the second direction Y. In this way, more flow paths are provided for the coolant, thereby ensuring smooth circulation of the coolant in the inlet section 112.

It is noted that in the example in FIG. 4, N is set to 3, namely the first flow-diverting members 113 are grouped into 3 first flow-diverting member groups A arranged at intervals along the first direction X. In practical applications, N may be selected according to the requirements, for example, N may be 2, 4, 5, or 6, etc. Moreover, in the example in FIG. 4, one first flow-diverting member group A includes 9 first flow-diverting members 113, with at least some of the first flow-diverting members 113 varying in size. Another first flow-diverting member group A includes 7 first flow-diverting members 113, with at least some of the first flow-diverting members 113 varying in size. Still another first flow-diverting member group A includes 2 first flow-diverting members 113 of different dimensions. In practical applications, there is no restriction on the number of first flow-diverting members 113 included in a single first flow-diverting member group A, nor on the dimension relationships among first flow-diverting members 113, and modifications can be made as needed. Additionally, in FIG. 4, a first flow-diverting member group A is schematically denoted by a dashed box.

In some embodiments, with reference to FIG. 4, in the first direction X, one respective first flow-diverting member 113 of a N-th first flow-diverting member group A has a width greater than or equal to a width of one respective first flow-diverting member 113 of a (N−1)-th first flow-diverting member group A. In some cases, in the first direction X, the first flow-diverting members 113 of different first flow-diverting member groups A may gradually increase in width.

In some embodiments, with reference to FIG. 4, in the second direction Y, the length of one respective first flow-diverting member 113 of the N-th first flow-diverting member group A is greater than or equal to the length of at least one first flow-diverting member 113 of the (N−1)-th first flow-diverting member group A, allowing the coolant to flow as evenly as possible in the coolant channel 102.

In some embodiments, with reference to FIG. 4, in the second direction Y, two adjacent first flow-diverting members 113 of a same first flow-diverting member group A are different in length. In some other embodiments, in the second direction Y, two adjacent first flow-diverting members 113 of a same first flow-diverting member group A are equal in length.

The following provides a detailed description of the third flow-diverting members 133.

In some embodiments, referring to FIG. 5, FIG. 5 is a schematic top view of partial structures of the turning section and the outlet section of the coolant channel in the enclosure according to some embodiments of the present disclosure. At least some of the third flow-diverting members 133 arranged in the outlet section 132 are partially arranged in the turning section 122.

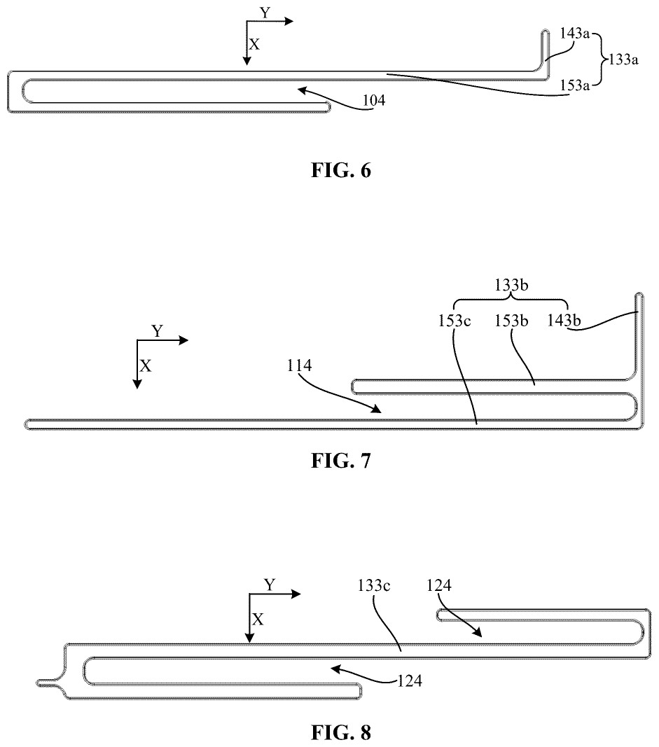

In some embodiments, referring to FIG. 5 and FIG. 6, FIG. 6 is a schematic top view of a structure of a first flow-diverting portion in the enclosure according to some embodiments of the present disclosure, one respective third flow-diverting member of the third flow-diverting members 133 includes at least a first flow-diverting portion 133a including a first flow-blocking portion 143a located in the turning section 122 and a first flow-guiding portion 153a located in the outlet section 132. The first flow-guiding portion 153a forms a first groove 104 extending toward the turning section 122 along the second direction Y.

The first flow-blocking portion 143a located in the turning section 122 is configured to redirect the coolant flowing through the inlet section 112 so that the coolant flows into the outlet section 132. The first flow-guiding portion 153a functions as the sidewall of the coolant channel in the outlet section 132.

In some embodiments, with reference to FIG. 5 and FIG. 7, FIG. 7 is a schematic top view of a structure of a second flow-diverting portion in the enclosure according to some embodiments of the present disclosure, one respective third flow-diverting member of the third flow-diverting members 133 further includes a second flow-diverting portion 133b including a second flow-guiding portion 153b, a third flow-guiding portion 153c, and a second flow-blocking portion 143b located in the turning section 122 and between the second flow-guiding portion 153b and the third flow-guiding portion 153c in the first direction X. The second flow-blocking portion 143b is respectively connected to the second flow-guiding portion 153b and the third flow-guiding portion 153c and forms a second groove 114 together with the second flow-guiding portion 153b and the third flow-guiding portion 153c, and the second groove 114 extends away from the turning section 122 along the second direction Y.

The first flow-blocking portion 143a in the turning section 122 is configured to redirect the coolant flowing through the inlet section 112 and the turning section 122 and direct the coolant into the outlet section 132. The second flow-guiding portion 153b and the third flow-guiding portion 153c are configured to form the sidewalls of the coolant channel in the outlet section 132.

It is noted that the second flow-blocking portion 143b may be considered as partially located in the turning section 122 and partially located in the outlet section 132. For example, the portion of the second flow-blocking portion 143b located between the second flow-guiding portion 153b and the third flow-guiding portion 153c in the first direction X may be considered as located in the outlet section 132.

In some embodiments, with reference to FIGS. 5 to 8, FIG. 8 is a schematic top view of a structure of a third flow-diverting portion in the enclosure according to some embodiments of the present disclosure. one respective third flow-diverting member of the third flow-diverting members 133 further includes a third flow-diverting portion 133c located between the first flow-diverting portion 133a and the second flow-diverting portion 133b. The third flow-diverting portion 133c is S-shaped, one end of the third flow-diverting portion 133c directly faces the first groove 104 along the second direction Y, and the other end of the third flow-diverting portion 133c directly faces the second groove 114 along the second direction Y. It can be understood that the third flow-diverting portion 133c also forms a sidewall of the coolant channel in the outlet section 132.

In some embodiments, with reference to FIG. 8, the third flow-diverting portion 133c forms two third grooves 124. Referring to FIG. 5, one respective third flow-diverting member of the third flow-diverting members 133 further includes fourth flow-diverting portions 133d, one of the fourth flow-diverting portions 133d is arranged between the first flow-diverting portion 133a and the third flow-diverting portion 133c, and the other of the fourth flow-diverting portions 133d is arranged between the second flow-diverting portion 133b and the third flow-diverting portion 133c. With reference to FIGS. 5 to 8, one respective fourth flow-diverting portion of the fourth flow-diverting portions 133d is Z-shaped, one end of the respective fourth flow-diverting portion 133d is located in the first groove 104 or the second groove 114, and the other end of the respective fourth flow-diverting portion 133d is located in the third groove 124. It can be understood that the fourth flow-diverting portions 133d also are configured to form sidewalls of the coolant channel in the outlet section 132.

In one example, with reference to FIG. 5, the first flow-diverting portion 133a, the second flow-diverting portion 133b, the third flow-diverting portion 133c, and the fourth flow-diverting portions 133d cooperate with each other to form a path for the coolant to flow in the outlet section 132, thereby forming the coolant channel 102 in the outlet section 132. In some other embodiments, the third flow-diverting member may include one, two, or three of the first flow-diverting portion, the second flow-diverting portion, the third flow-diverting portion, and the fourth flow-diverting portions.

In some embodiments, with reference to FIG. 1 or FIG. 2, the enclosure 101 further includes: an inlet 111 arranged on a side of the inlet section 112 away from the turning section 122 in the second direction Y, and an outlet 121 arranged on a side of the outlet section 132 away from the turning section 122 in the second direction Y, where the second direction Y refers to the length direction of the enclosure 101.

It is noted that in order to illustrate the approximate locations of the inlet 111 and the outlet 121 in the enclosure 101, FIG. 1 and FIG. 2 only schematically show the inlet 111 and the outlet 121 with circles, without illustrating the specific shape of the inlet 111 and the outlet 121.

In some embodiments, with reference to FIG. 1 or FIG. 2, a flow rate of a coolant has a first average value in the inlet section 112, the flow rate of the coolant has a second average value in the turning section 122, and the flow rate of the coolant has a third average value in the outlet section 132. The first average value is less than the second average value, and the second average value is less than the third average value. In other words, the average value of flow rate in the inlet section 112, the average value of flow rate in the turning section 122, and the average value of flow rate in the outlet section 132 are in ascending order, so that with the increasing time the coolant flows in the coolant channel, the flow rate of the coolant represents an overall increasing trend. It is noted that as the coolant spends more time in the coolant channel, its temperature will increase. Based on this, the design of the enclosure 101 according to some embodiments of the present disclosure is beneficial in ensuring that the flow rate of the coolant represents an overall increasing trend. Increasing the flow rate of the coolant can help compensate for the impact of the temperature rise of the coolant on the cooling performance, thereby ensuring that the coolant in the inlet section 112, the turning section 122, and the outlet section 132 all provide excellent cooling effects for the battery cells.

In some embodiments, with reference to FIG. 1 or FIG. 2, a flow resistance experienced by a coolant has a first average value in the inlet section 112, the flow resistance experienced by the coolant has a second average value in the turning section 122, and the flow resistance experienced by the coolant has a third average value in the outlet section 132. The first average value is greater than the third average value, and the third average value is greater than the second average value. In other words, the average value of flow resistance in the inlet section 112, the average value of flow resistance in the outlet section 132, and the average value of flow resistance in the turning section 122 are in descending order, with the average value of flow resistance in the turning section 122 being the smallest. It is noted that the coolant primarily flows along the second direction Y in both the inlet section 112 and the outlet section 132, namely the flow direction of the coolant in the inlet section 112 and the outlet section 132 does not change significantly. However, the turning section 122 serves to connect the inlet section 112 and the outlet section 132, and the flow direction of the coolant changes as it flows from the inlet section 112 into the turning section 122. Similarly, as the coolant flows from the turning section 122 into the outlet section 132, its flow direction changes again. Therefore, the design of the enclosure 101 according to some embodiments of the present disclosure helps minimize the average flow resistance in the turning section 122. This ensures that the flow rate does not drop too much when the coolant changes its flow direction in the turning section 122, thereby ensuring good cooling effect of the coolant in the turning section 122 on the battery cells.

Furthermore, the coolant first enters the inlet section 112, where the coolant spends a shorter time absorbing heat from the battery cells compared to the turning section 122 and the outlet section 132. Thus, the coolant in the inlet section 112 has a lower temperature. Based on this, the design of the enclosure 101 according to some embodiments of the present disclosure helps ensure that the average flow resistance experienced by the coolant in the inlet section 112 is greater than the average flow resistance in the outlet section 132. This allows the cooler coolant to flow for longer duration in the inlet section 112, providing more thorough cooling for the battery cells, while the warmer coolant can flow through the outlet section 132 more quickly, expelling the higher-temperature coolant from the enclosure 101 faster. Therefore, the first average value is greater than the third average value, and the third average value is greater than the second average value, which overall improves the cooling performance of the coolant on the battery cells.

In summary, flow-diverting members 103 for disturbing the flow of the coolant are respectively arranged in the inlet section 112, the outlet section 132, and the turning section 122. In this way, flow rate of the coolant in the coolant channel 102 can be increased, thereby improving the cooling performance of the coolant. The increased flow rate of the coolant also helps prevent impurities in the coolant from depositing in the coolant channel 102, thereby increasing the service life of the enclosure 101. Furthermore, the first width W1 of the inlet section 112 is smaller than the second width W2 of the outlet section 132, which helps constrict the flowing space in the coolant channel 102 for the coolant, i.e. constricting the volume of the inlet section 112, thereby increasing the flow rate of the coolant at the inlet of the coolant channel 102. When the coolant flows into the outlet section 132, the larger volume of the outlet section 132 can gradually reduce the flow rate of the coolant, thereby increasing the duration of the coolant flowing in the outlet section 132, and further improving the cooling performance of the coolant.

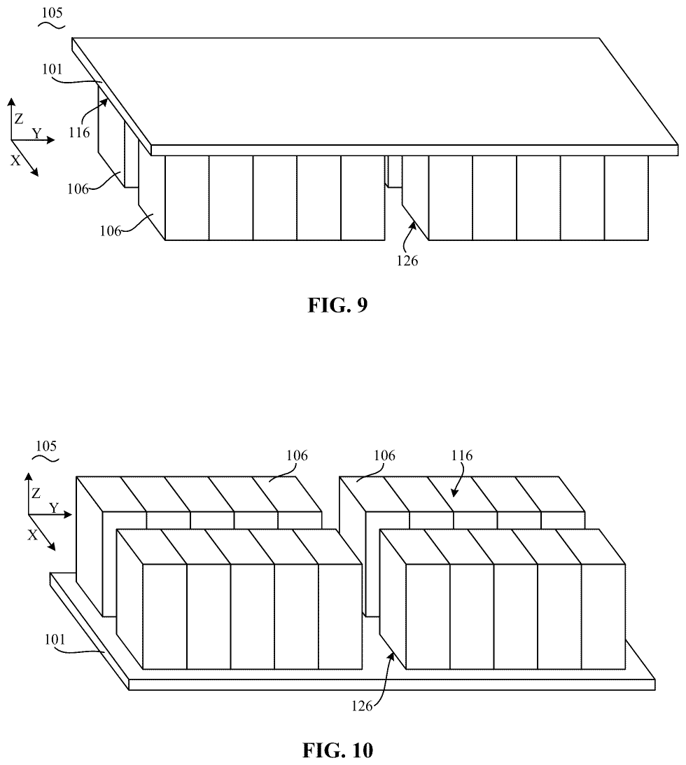

Some embodiments of the present disclosure provide a battery pack. With reference to FIG. 9 or FIG. 10, the battery pack 105 includes the enclosure 101 according to the previous embodiments. It is noted that the parts same as or corresponding to those in the previous embodiments will not be repeated here.

In some embodiments, with reference to FIG. 9 or FIG. 10, FIG. 9 is a schematic perspective view of a partial structure of a battery pack according to some embodiments of the present disclosure, and FIG. 10 is a schematic perspective view of another partial structure of the battery pack according to some embodiments of the present disclosure. The battery pack 105 further includes: a plurality of cells 106. Each cell of the plurality of cells 106 include a top surface 116 and a bottom surface 126 that are opposite to each other along a third direction Z. The third direction Z refers to a thickness direction of the enclosure 101.

In some embodiments, with reference to FIG. 9, the enclosure 101 is located on a side of the top surface 116 away from the bottom surface 126. In other words, the enclosure 101 can serve as the top cover of the battery pack 105, and the top cover is provided with a coolant channel 102 to cool the cells.

In some other embodiments, with reference to FIG. 10, the enclosure 101 is located on a side of the bottom surface 126 away from the top surface 116. In other words, the enclosure 101 can serve as the bottom plate of the battery pack 105, and the bottom plate is provided with a coolant channel 102 to cool the cells.

It is noted that FIG. 9 and FIG. 10 show two application scenarios of the enclosure 101 in the battery pack 105. In practical applications, the positional relationship between the enclosure 101 and other components in the battery pack 105, such as the cells 106, may be flexibly adjusted depending on requirements. In addition, FIG. 9 and FIG. 10 each illustrate one arrangement example for the cells 106 in the battery pack 105. In actual applications, the number of cells 106 in the battery pack 105, as well as the arrangement and connection among the plurality of cells 106, are not limited and may be designed as needed.

In summary, both the cooling performance and service life of the enclosure 101 can be improved based on the design of the coolant channel in the enclosure 101. Therefore, the enclosure 101 applied to the battery pack 105 can enhance the heat dissipation of heat-generating components, such as the cells 106, in the battery pack 105, thereby contributing to the extended service life of the battery pack 105. Moreover, the enclosure 101 used as the casing of the battery pack 105 and the liquid cooled plate are integrated into a single piece, which helps reduce the layout space occupied by the casing of the battery pack 105 and the liquid cooled plate in the battery pack 105. This allows more internal space in the battery pack 105 to be used for accommodating the cells 106, thereby increasing the energy density of the battery pack 105 without increasing its overall volume.

Some embodiments of the present disclosure provide an energy storage system. With reference to FIGS. 1 to 8, the energy storage system includes the enclosure 101 as illustrated in the previous embodiments, or, with reference to FIG. 9 or 10, the energy storage system includes the battery pack 105 as illustrated in the previous embodiments. It is noted that the parts same as or corresponding to those in the previous embodiments are not repeated here.

In some embodiments, the energy storage system includes a plurality of battery packs 105 that are electrically connected in sequence.

It is noted that in some other embodiments of the present disclosure, the number of battery packs 105 included in the energy storage system is not limited.

Those skilled in the art will appreciate that the embodiments described above are specific implementations of the present disclosure, and in practical applications, various modifications may be made in terms of form and details without departing from the spirit and scope of the disclosure. Those skilled person in the art can make various changes and modifications without departing from the spirit and scope of the present disclosure. Therefore, the protection scope of the present disclosure is subject to the scope defined by the claims.

What is claimed is:

1. An enclosure for a battery pack, comprising:
a coolant channel arranged inside the enclosure, wherein the coolant channel is configured to conduct a coolant inside and includes an inlet section, an outlet section, and a turning section connecting the inlet section with the outlet section; and
a plurality of flow-diverting members configured to distribute flow of the coolant through the coolant channel, wherein the plurality of flow-diverting members include first flow-diverting members arranged in the inlet section, second flow-diverting members arranged in the turning section, and third flow-diverting members arranged in the outlet section;
wherein in a width direction of the enclosure, the inlet section has a first width smaller than a second width of the outlet section.

2. The enclosure according to claim 1, wherein the first flow-diverting members are arranged at a first distribution density, the second flow-diverting members are arranged at a second distribution density, and the third flow-diverting members are arranged at a third distribution density, and wherein the second distribution density is greater than the first distribution density, and the second distribution density is greater than the third distribution density.

3. The enclosure according to claim 2, wherein the first distribution density is greater than the third distribution density.

4. The enclosure according to claim 1, wherein in a length direction of the enclosure, one respective first flow-diverting member of the first flow-diverting members has a first length, one respective second flow-diverting member of the second flow-diverting members has a second length, and one respective third flow-diverting member of the third flow-diverting members has a third length, wherein the third length is greater than the first length, the third length is greater than the second length, and the first length is greater than second lengths of at least some of the second flow-diverting members.

5. The enclosure according to claim 4, wherein each first flow-diverting member of the first flow-diverting members is configured as an elongated structure extending along the length direction.

6. The enclosure according to claim 1, wherein the first flow-diverting members are grouped into N first flow-diverting member groups arranged at intervals along the width direction, each first flow-diverting member group of the N first flow-diverting member groups includes a respective plurality of first flow-diverting members arranged at intervals along the length direction, and N is a positive integer greater than or equal to 2; and
wherein in the width direction, one respective first flow-diverting member of a N-th first flow-diverting member group has a width greater than or equal to a width of one respective first flow-diverting member of a (N−1)-th first flow-diverting member group.

7. The enclosure according to claim 1, wherein at least some of the third flow-diverting members are partially arranged in the turning section.

8. The enclosure according to claim 7, wherein one respective third flow-diverting member of the third flow-diverting members includes at least a first flow-diverting portion including a first flow-blocking portion located in the turning section and a first flow-guiding portion located in the outlet section, and the first flow-guiding portion forms a first groove extending toward the turning section along a length direction of the enclosure.

9. The enclosure according to claim 8, wherein one respective third flow-diverting member of the third flow-diverting members further includes a second flow-diverting portion including a second flow-guiding portion, a third flow-guiding portion, and a second flow-blocking portion located in the turning section and between the second flow-guiding portion and the third flow-guiding portion in the width direction, and wherein the second flow-blocking portion is respectively connected to the second flow-guiding portion and the third flow-guiding portion and forms a second groove together with the second flow-guiding portion and the third flow-guiding portion, and the second groove extends away from the turning section along the length direction.

10. The enclosure according to claim 9, wherein one respective third flow-diverting member of the third flow-diverting members further includes a third flow-diverting portion located between the first flow-diverting portion and the second flow-diverting portion, the third flow-diverting portion is S-shaped, one end of the third flow-diverting portion directly faces the first groove along the length direction, and the other end of the third flow-diverting portion directly faces the second groove along the length direction.

11. The enclosure according to claim 10, wherein the third flow-diverting portion forms two third grooves, one respective third flow-diverting member of the third flow-diverting members further includes fourth flow-diverting portions, one of the fourth flow-diverting portions is arranged between the first flow-diverting portion and the third flow-diverting portion, and the other of the fourth flow-diverting portions is arranged between the second flow-diverting portion and the third flow-diverting portion; and
wherein one respective fourth flow-diverting portion of the fourth flow-diverting portions is Z-shaped, one end of the respective fourth flow-diverting portion is located in the first groove or the second groove, and the other end of the respective fourth flow-diverting portion is located in the third groove.

12. The enclosure according to claim 1, wherein a ratio of the second width to the first width ranges from 1.5 to 2.5.

13. The enclosure according to claim 1, further including:
an inlet arranged on a side of the inlet section away from the turning section in a length direction of the enclosure; and
an outlet arranged on a side of the outlet section away from the turning section in the length direction.

14. The enclosure according to claim 1, wherein the turning section includes a first section and a second section, the first section directly faces the inlet section along a length direction of the enclosure, and the second section directly faces the outlet section along the second direction.

15. The enclosure according to claim 14, wherein the outlet section includes a third section and a fourth section, the third section directly faces the inlet section along the width direction, and the fourth section directly faces the turning section along the width direction.

16. The enclosure according to claim 1, wherein a distance between the inlet section and the outlet section along the width direction is in a range of 35 mm to 52 mm.

17. The enclosure according to claim 1, wherein a flow rate of a coolant has a first average value in the inlet section, the flow rate of the coolant has a second average value in the turning section, and the flow rate of the coolant has a third average value in the outlet section, and wherein the first average value is less than the second average value, and the second average value is less than the third average value.

18. The enclosure according to claim 1, wherein a flow resistance experienced by a coolant has a first average value in the inlet section, the flow resistance experienced by the coolant has a second average value in the turning section, and the flow resistance experienced by the coolant has a third average value in the outlet section, and wherein the first average value is greater than the third average value, and the third average value is greater than the second average value.

19. A battery pack, including the enclosure according to claim 1;
wherein the battery pack further includes a plurality of cells, wherein each cell of the plurality of cells includes a top surface and a bottom surface that are opposite to each other along a thickness direction of the enclosure; and
wherein the enclosure is located on a side of the top surface away from the bottom surface, or the enclosure is located on a side of the bottom surface away from the top surface.

20. An energy storage system, including the battery pack according to claim 19.
